(19) United States
(12) Patent Application Publication
(10) Pub. No.: US 2016/0244637 A1
(43) Pub. Date: Aug. 25, 2016

(54) Chromium-Free Water Based Coating for Treating a Galvannealed or Galvanized Steel Surface

(71) Applicant: TATA STEEL LIMITED, Jamshedpur (IN)

(72) Inventors: Akshay Kumar Guin, Jamshedpur (IN); Manish Kumar Bhadu, Jamshedpur (IN); Kedar Shashikant Bhave, Jamshedpur (IN); Mohua Rani Sinhababu, Jamshedpur (IN); Rajesh Shyam Pais, Jamshedpur (IN)

(21) Appl. No.: 15/026,259

(22) PCT Filed: Sep. 24, 2014
(86) PCT No.: PCT/IN2014/000617

§ 371 Date: Mar. 31, 2016

(30) Foreign Application Priority Data
Oct. 1, 2013 (IN) 1135KOL/2013

(51) Int. Cl. C09D 183/06; C09D 5/08

(52) U.S. Cl. CPC C09D 183/06; C09D 5/08

(57) ABSTRACT

A chromium-free water based coating for treating a galvannealed or galvanized steel surface. The coating is based upon a hybrid condensation product of a water soluble sol-gel solution prepared from a solution containing one or more organo-functional silanes. The silane solution is hydrolised at pH 4-6.5 for 16 hours at room temperature with continuous stirring at a speed of 300-800 rpm. The coating composition when applied on a galvanized or galvannealed steel substrate provides more than 200 hours of white rust resistance at a coating thickness of less than 5 micron and can dry within 10-30 seconds at 80-90° C. peak metal temperature.

### FIELD OF THE INVENTION

This invention relates to an eco-friendly, chromium-free corrosion resistance polymer coating composition for metallic surfaces such as galvannealed, galvanized or cold rolled steel substrate. More particularly, the invention relates to an eco-friendly water based corrosion resistance coating composition for steel substrate providing 200 h of white rust resistance on galvanized and Galvannealed steel substrate.

### BACKGROUND OF THE INVENTION

Metals such as iron, aluminum, copper and magnesium and their alloys have wide applications in different industrial and household components. These metals are useful in industry because of their stiffness and high strength to weight characteristics, but they are highly susceptible to corrosion in aggressive environments. Corrosion is the major reason of energy and material loss. In spite of much advancement in the field of corrosion science and technology, the phenomenon of corrosion (mainly of Fe, Al, Cu, Zn, Mg and their alloys) remains a major concern to industries around the world. There are highly corrosion resistant materials but the cost becomes the constraint on use of these materials. Hence, use of cheap metallic materials along with efficient corrosion prevention methods is researched for years in many industrial applications.

To reduce the corrosion at least, two approaches are known to be utilized: for example, passive. corrosion protection and active corrosion protection. Passive corrosion protection is normally provided by a barrier film that prevents contact of corrosive species with the metal surface and therefore hinders the corrosion process. However, in the cases when a defect is formed in the barrier layer, the coating cannot stop corrosion in this place. The second approach is active corrosion protection, which employs inhibitive species that can decrease corrosion activity.

Industrial protection systems comprise different layers such as pre-treatment, primer and top coating. Pre treatment plays an important role of intermediate layer that increases adhesion between the metal surface and the organic coating and also provides an additional barrier and, eventually, active corrosion properties. Chromate conversion coatings have been used as pre treatments for a long time due to a good adhesion as well as active corrosion protection. However, the use of chromates has been an environmental hazard because of the carcinogenic activity and toxicity. A generic way to protect metals from corrosion is to apply protective films coatings. The protective film coatings allow the desired properties of the substrate to be coated through a chemical modification of the coatings, such as mechanical strength, optical appearance etc. There are several techniques for the deposition of coatings on metals, including physical vapour deposition, chemical vapour deposition, electrochemical deposition plasma spraying and sol-gel process.

The sol-gel process is a chemical synthesis method described as the creation of an oxide network by progressive condensation reactions of molecular precursors in a liquid medium. There are two ways to prepare sol-gel coatings: the inorganic method and the organic method. The inorganic method involves the evolution of networks through the formation of a colloidal suspension and gelation of the sol to form a network in continuous liquid phase. Organic phase is the most widely used, which starts with a solution of monomeric metal or metalloid alkoxide precursors M (OR)n in an alcohol or other low molecular weight organic solvent. Here M represents a network forming element, such as Si, Ti, Zr, Al etc. and R is typically an alkyl group.

The sol-gel formation occurs in four stages: (a) hydrolysis (b) condensation and polymerization of monomers to form chains and particles (c) growth of the particles (d) agglomeration of the polymer structures followed by the formation of networks that extend throughout the liquid medium resulting in thickening, which forms a gel. Hydrolysis and condensation reactions occur simultaneously. A sol-gel coating can be applied to a metal substrate through various methods, such as dip-coating and spin coating, which are most commonly used.

Furthermore, in order to improve the performance of these silica sol-gels, corrosion inhibitors are added. The purpose of this approach is to avoid the leaching of the inhibitor from the zones of corrosion.

### PRIOR ART

JP2007070572 discloses a coating material composition that has improved rust prevention property in the heat affected zone. The composition includes an acryl amino type thermosetting resin, a silicate compound and thiazole type compound, and/or silane coupling agent.

KR20090070024 discloses a chromium-free processing liquid based upon a binder resin, silicate, silane, titanium, urethane resin and epoxy resin, titanium carbonate, and titanium phosphate. The invention claims chromium-free surface-treated steel plate for use in fuel tank and comprises chromium-free layer and electro-galvanized zinc-based metal plated steel sheet.

Patent applications KR20090065020 and WO2007075050 also disclose surface treated. Cr-free steel sheet for use in a fuel tank. All these disclosed inventions teach corrosion protection of 24-48 hours on galvanized sheet. The dry film thickness of the coated galvanized sheet is in the range of 5-30 micron meter and wet coating dry at more than 100 deg C.

Indian patent application number:1328/KOL/2012 describes a water based coating which can provide 500 h red rust corrosion resistance on Galvannealed substrate and the same coating solution show only 48 h of white rust resistance on Galvannealed substrate and provide less than 24h of white rust resistance on galvanized substrate.

Although, quite a few formulations are known in the art, a need still exists for formulations that can provide corrosion resistance for higher durations. In light of the above discussed prior art, there is a need for chrome free coatings having high corrosion resistance and good adhesion property, at low film thickness, preferably less than equal to 5 micron thickness. Further, the coating should be capable for easy-application on Galvannealed and galvanized steel substrate by well known techniques such as spray, brush and roll coater. Further, the chrome free coating should have good forming properties including fast drying property on the metallic substrate, preferably at below 90 deg C.

### OBJECTS OF THE INVENTION

It is therefore an object of the present invention to propose an eco-friendly water based corrosion resistance coating composition for steel substrate providing 200 h of white rust resistance on galvanized and Galvannealed steel substrate.

Another object of the present invention is to propose an eco-friendly water based corrosion resistance coating composition for steel substrate providing 200 h of white rust resistance on galvanized and Galvannealed steel substrate, which is resistant to petrol and diesel.

Still another object of this invention is to propose an eco-friendly water based corrosion resistance coating composition for steel substrate providing 200 h of white rust resistance on galvanized and Galvannealed steel substrate, that allows uniform coating on the steel surface, when applied by spray, brush, dip or roll coater.

Yet another object of this invention is to propose an eco-friendly water based corrosion resistance coating composition for steel substrate providing 200 h of white rust resistance on galvanized and Galvannealed steel substrate, which gets dried below 90° Centigrade within 10 to 30 seconds.

A further object of the invention is to propose a steel sheet coated with an eco-friendly chromium free coating.

A still further object of the invention is to propose a fuel tank coated with chromium free anti-corrosive coating.

### DETAILED DESCRIPTION OF THE INVENTION

According to this invention, there is provided an eco-friendly corrosion resistance coating for steel or metallic substrates that comprises 10-90% by weight of water based poly condensed hybrid reaction product of a silane solution , 0.5-5% by weight of a hydrolysing agent, 0.1-3% by weight of a flash rust inhibitor, 0.05-5% by weight of a curing agent, 0.5-30% film forming agent, 0.5-20% pigment and 0.0-2% defoamer and leveling agent. The remaining portion of the coating is water based upon 100 percent by weight of the total coating composition.

According to the invention, one or more of the objectives of the invention may be achieved by applying the eco-friendly coating on steel substrate. The eco-friendly coating comprising at least one organofunctional silanes group applied on to the steel substrate. Thereafter, the coating mixture is cured so as to provide a dense network structure of coating for protection of the substrate from corrosion and gasoline environment.

The primary organofunctional silane compound used in the embodiments of the invention includes hybrid condensation product of water soluble sol-gel solution prepared from a solution containing one or more organofunctional silanes. In one embodiment, organofunctional silanes such as glycidoxypropyltrimethoxysilane (GPTMS) 0.5-20 wt %, tetraethoxy silane (TEOS) 0-5 wt %, vinyl trimethoxy silane (VTMS)0.1-20%, mercaptopropyl trimethoxy silane 0.5-10 wt %. and aminopropyl triethoxy silane 0.1-10 wt % are used. Besides the organofunctional group, it also contains organic functionality based on Si bond epoxy group. The above silane solution is hydrolised at pH 4-6.5 for 16 h at room temperature with continuous stirring at a speed of 300-800 rpm.

The hydrolysing agent is used to hydrolyse the silane compound and to create free hydroxyl group, which free hydroxyl group form a chemical bond between the polymer and metal. The hydrolysing agent used in the present invention is one of hydrochloric acid, nitric acid, acetic acid, and formic acid, but not limited to the exemplary agents.

The coating mixture may comprise an aqueous solution of flash rust inhibitor. The flash rust inhibitor is used to restrict or delay the onset of under film corrosion or pre cure corrosion. Preferred examples of the flash rust inhibitors that may be used as per the present invention include compounds such as sodium nitrite, benzotriazole and a mixture of one or more of 10-25% of C₁₂-C₁₄ (2-benzothiazolylthio) succinic acid tertiary amine salts, 10-25% of ethoxylated tridecylalcohol phosphate-comprising monoethanolamine salts, 10-25% of zinc salts of branched (C₆-C₁₉) fatty acids, <2.5% of zinc salts of naphthenic acid, 10-25% morpholine benzoate. The flash rust inhibitor used in the present invention has the following physical properties:
Density (200C) : approx. 1.04 gm/cm³
viscosity (200C) : <200 mPa.s
pH-value: 8-10

Curing agent is used to accelerate the rate of reaction and to reduce the curing temperature. The present invention includes curing agent but is not limited to polycabodiimides, aziridines, butyl diethanol amine or any combination thereof. The present invention includes a film forming agent, which adsorbes on steel substrate and enhances the film thickness of the applied coating. This film forming agent includes but is not limited to ethylene glycol, polyethylene glycol, ethyl silicate or any combination thereof.

In another embodiment of the invention, the coating mixture may comprise a corrosion resistance pigment. Preferred examples of the corrosion resistance pigments as per the present invention include nano zinc oxide, nano silica, nano alumina, nano cerium oxide, zirconium nitrate, lithium nitrate, zinc phosphate, zinc phosphate derivatives or any combination thereof.

The eco-friendly corrosion resistant coating of the invention can be applied to steel substrates using any of well-known coating methods such as dipping, spraying, roll coating and brush coating. The coating weight of the composition is not particularly limited. However, the coating is applied so as to give a coating thickness in the range of 500 nm to 200 micron.

### EXAMPLES

The present invention will be described with reference to the following examples. These examples are provided only for illustrating the present invention and should not be construed as limiting the scope of the present invention. Commercially available Galvannealed and galvanized steel substrate was used as the metal material for applying the coating of the present invention.

### Example 1

| Coating Ingredient | Composition by weight % |
|---|---|
| Hybrid condensation product of sol-gel | 10 |
| solution | |
| Hydrolysing agent | 0.5 |
| Flash rust inhibitor | 0.5 |
| Curing agent | 3 |
| Pigment | 1 |
| Wetting and defoaming agent | 0.2 |
| Film forming agent | 5 |
| Water | 79.8 |

The coating formulation of example 1 when applied on galvanized steel substrate provides uniform coating with 0.5 to 2 micron dry film thickness. The coating formulation provided SST life in the range of 24-72 hours as per ASTM B117 standard.

### Example 2

| Coating Ingredient | Composition by weight % |
|---|---|
| Hybrid condensation product of sol-gel | 70 |
| solution | |
| Flash rust inhibitor | 0.5 |
| Curing agent | 3 |
| Pigment | 1 |
| Wetting and defoaming agent | 0.5 |
| Film forming agent | 25 |

The coating formulation of example 2 when applied on Galvannealed steel substrate provides uniform coating with 0.5 to 10 micron dry film thickness. The coating formulation provided more than 200 h white rust resistance life as per ASTM B117 standard. Also, the coated Galvannealed steel sheet provides more than one year resistance to petrol and diesel in static immersion conditions. The coating formulation of example 2, when applied on galvanized steel substrate provides uniform coating with 0.5 to 10 micron dry film thickness. The coating formulation provides corrosion resistance of 24 to 200 h salt spray resistance for white rust resistance as per ASTM B117 standard.

The disclosed eco-friendly coating of the present invention provides a very good adhesion and corrosion resistance to Galvannealed and galvanized steel substrate. Further, the coated galvannealed and galvanised steel substrate is weldable and formable and can withstand corrosion resistance to petrol, diesel and acidic environment.

The present invention is about the development of new coating chemistry which can applied on galvanized and galvannealed steel substrate to provide more than 200 h of white rust resistance at a coating thickness of less than 5 micron and can dry within 10-30 sec at 80-90 deg C. peak metal temperature. This coating formulation can be applied on Galvannealed, galvanised, Al and Cu, Sn substrate and has a high potential to replace chrome pretreatment process.

1. A chromium-free coating composition for treating a metal-surface, the coating composition comprising:
10-90 percent by weight of a water based poly condensed silane solution comprising of one or more organo-functional silanes;
0.5-5 percent by weight of a hydrolysing agent;
0.1-3 percent by weight of a flash rust inhibitor;
0.05-5 percent by weight of a curing agent;
0.5-30 percent by weight of a film forming agent;
0.5-20 percent by weight of a pigment;
0-2 percent by weight of a defoamer and leveling agent;
the balance being water based upon 100 percent by weight of the total coating composition.

2. The coating composition as claimed in claim 1, wherein the hydrolysing agent is selected from the group consisting of hydrochloric acid, nitric acid, and acetic acid.

3. The coating composition as claimed in claim 1, wherein the one or more organofunctional silanes is at least one of glycidoxypropyltrimethoxysilane (GPTMS) 0.5-20 wt %, tetraethoxy silane (TEOS) 0-5 wt %, vinyl trimethoxy silane (VTMS) 0.1-20 wt %, mercaptopropyl trimethoxy silane 0.5-10 wt %, and aminopropyl triethoxy silane 0.1-10 wt %.

4. The coating composition as claimed in claim 1, wherein the water based poly condensed silane solution comprising of one or more organo-functional silanes is hydrolised at pH 4-6.5 for 16 hours at room temperature with continuous stirring at a speed of 300-800 rpm.

5. The coating composition as claimed in claim 1, wherein the flash rust inhibitor is selected from the group consisting of sodium nitrite, benzotriazole, 10 25% of C₁₂-C₁₄ (2-benzothiazolylthio) succinic acid tertiary amine salts, 10-25% of ethoxylated tridecylalcohol phosphate-comprising monoethanolamine salts, 10-25% of zinc salts of branched (C₆-C₁₉) fatty acids, <2.5% of zinc salts of naphthenic acid, 10-25% morpholine benzoate, and mixtures thereof.

6. The coating composition as claimed in claim 1, wherein the curing agent is butyl diethanol amine or a derivative of butyl diethanol amine.

7. The coating composition as claimed in claim 1, wherein the film forming agent is selected from the group consisting of ethylene glycol, poly ethylene glycol, ethyl silicate, and mixtures thereof.

8. The coating composition as claimed in claim 1, wherein said defoamer and leveling agent is a silicon solution or a derivative of a silicon solution.

9. The coating composition as claimed in claim 1, wherein the coating composition further comprises a pigment.

10. The coating composition as claimed in claim 9, wherein the pigment is selected from the group consisting of zinc oxide, silica, alumina, cerium nitrate, cerium dibutyl phosphate, zirconium nitrate, lanthanum nitrate, and a combinations thereof.

11. A steel substrate coated with the chromium-free coating composition as claimed in claim 1.

12. A fuel tank coated with the chromium-free coating composition as claimed in claim 1.

13. The steel substrate as claimed in claim 11, wherein a thickness of the coating composition formed from the coating is 500 nm to 200 micron.

14. The fuel tank as claimed in claim 12, wherein a thickness of the coating composition formed from the coating is 500 nm to 200 micron.

15. The steel substrate as claimed in claim 11, wherein the steel substrate is a galvannealed steel substrate.

16. The steel substrate as claimed in claim 11, wherein the steel substrate is a galvanized steel substrate.

17. The coating composition as claimed in claim 1, wherein pH of the coating composition 3 to 9.

18. The steel substrate as claimed in claim 11, wherein the coated steel-surface is weldable.
